(19) United States
(12) Patent Application Publication
(10) Pub. No.: US 2007/0083668 A1
(43) Pub. Date: Apr. 12, 2007

(54) Method and apparatus for facilitating network expansion

(75) Inventors: Nicholas Kelsey, Sunnyvale, CA (US); Christopher Waters, Los Altos, CA (US)

Correspondence Address: HELLER EHRMAN LLP, 275 MIDDLEFIELD ROAD, MENLO PARK, CA, 94025-3506, US

(73) Assignee: Network Chemistry, Inc., Redwood City, CA (US)

(21) Appl. No.: 11/298,289

(22) Filed: Dec. 9, 2005

Related U.S. Application Data
(60) Provisional application No. 60/724,510, filed on Oct. 7, 2005.

(51) Int. Cl. G06F 15/173

(52) U.S. Cl. 709/238

(57) ABSTRACT

Systems and methods are provided for network expansion. In one embodiment of the present invention, a system is provided having a network connection device, a first network device, and a second network device. The first network device and the second network device may be coupled together in a network topology configured so that a single port on the network connection device supports network connectivity to both the first network device and second network device. The single port may provide power and data to an input port on the first network device. An output port on the first network device may provide power and data to the second network device. The network connection device may be a Power over Ethernet switch.

The present application claims the benefit of priority to copending U.S. Provisional Patent Application Ser. No. 60/724,510 (Attorney Docket No. 40645-1001) filed Oct. 7, 2005 and fully incorporated herein by reference for all purposes.

### BACKGROUND OF THE INVENTION

1. Technical Field

The present invention relates generally to networking and computer networks. More specifically, the present invention relates to wireless networks and network security devices for use in new or existing wireless local area networks.

2. Background

With the advancement of computer systems and deployment of broadband internet connections, computer networks have proliferated and are now commonly found in both commercial and residential settings. The convenience of 802.11-based wireless networks has further advanced the proliferation of local area networks in both business environments and consumer residences. The security on these various computer networks can vary widely from network to network, depending on the sophistication of the network administrator and the sensitivity of the data on the networks. For the 802.11-based wireless networks, security is an even greater concern because access to these wireless networks is much harder to control than in a wired network environment.

To improve network security, additional security devices or network elements may be introduced into the network to provide upgraded protection after the initial network deployment.

The addition of these network elements after initial network deployment is less of an issue in networks where plenty of network capacity and network ports are available. Some networks, however, may not have the capacity to include these additional network elements without more significant and more costly hardware upgrades. Such hardware upgrades may not make sense from an economic perspective and deter some network administrators from taking appropriate security measures.

Even for those networks with the excess capacity or network ports to support additional security equipment, the installation costs to add the cabling to support the new equipment may be quite substantial. For example, in a commercial building, the cost for pulling and snaking additional cable through the building may equal or exceed the cost of the additional security. For a wireless local area network in this example, when a plurality of wireless access points are provided in the network, there is typically a switch in a location such as a wiring closet for connecting these access points together. The cable connecting the various wireless access points to the switch may stretch up to 100 meters in length. To pull or lay this cable, the cost may be anywhere from $300 to $1000, depending on the labor and logistics of cutting openings in walls, pulling wire in walls, laying cable in ceilings or the like. As stated previously, this cost may exceed the cost of the new security device. Thus, the economics of implementing the cabling to support the desired security equipment may again dissuade a network administrator from implementing the appropriate security measures or implement them in only a limited deployment.

### SUMMARY OF THE INVENTION

The present invention provides solutions for at least some of the drawbacks discussed above. Specifically, some embodiments of the present invention provide improved methods and devices for facilitating the deployment of additional network equipment in new or existing networks. In one embodiment, the present invention is directed at deployment of network security devices. In a still further embodiment, the network device is a security device for use in a wireless local area network.

In one embodiment of the present invention, a network monitoring or security device can be connected inline with a Power over Ethernet (PoE) device such that both devices operate from the same Power over Ethernet power source and network connection. It should be understood that the network monitoring or security device may be a wireless network sensor. The Power over Ethernet device may be a wireless Access Point (AP). It should be understood that the present invention may relate to hardware design for a network security device with pass-through (passthru) power capabilities.

In another embodiment of the present invention, an apparatus is provided for use in a network to facilitate network expansion. The apparatus comprises a processor and a network interface. The network interface includes a first port for receiving power and data transmitted from a first network device and a second port for transmitting power and data to a second network device. The network interface may communicatively couple the processor to the network, wherein data received on the first port can be transmitted out the second port to an appropriate destination. It should be understood that the power received by the first port may be at a level that conforms to IEEE 802.3af standard.

In one embodiment of the present invention, the processor may be configured to route data from the first port or the second port to the appropriate destination. Data received on the second port can be transmitted out the first port. The apparatus may include a first circuit defining an input stage between the first port and the processor, wherein the input stage is configured to separate data from the power being received at the first port. The apparatus may also include a second circuit defining an output stage between the second port and the processor, wherein the output stage is configured to combine data with the power to be transmitted out the second port. The apparatus may function or operate on only a portion of the power received via the first port. In one embodiment, the apparatus may be or include a network intrusion detection sensor that operates on only a portion of the power received from the first port. A network intrusion detection sensor may be communicatively coupled to first circuit to receiving power from the first port. A wireless network intrusion detection sensor may be communicatively coupled to first circuit to receiving power from the first port. The first network device may be a Power over Ethernet switch. The first network device may be a device providing a wireless access point.

The power received by the first port may be at a level that conforms to IEEE 802.3af standard. The power transmitted by the second port may be at a level that conforms to IEEE 802.3af standard. In one embodiment, the power transmitted by the second port may be about 18 watts or less. The apparatus may have a power passthru configuration wherein power received on the first port is substantially the same as the power transmitted on the output port, without adding additional power. The processor may include includes a sensor network stack, wherein the processor is configured so that data coming upstream from a downstream network device cannot directly access the sensor network stack in the processor. The network interface may include a third port for transmitting power and data to a third network device. The processor may have a configuration sufficient to allow a software reboot of the device without interruption of power flowing through the apparatus to the second network device. The input stage may include logic configured to determine which power protocol is being used with the power being received. The output stage may include logic configured to determine which power protocol is to be used with the second network device. The input stage can be used with network devices using either IEEE 802.3af or Cisco pre-802.3af proprietary protocols. A device may be providing a function unrelated to routing of data.

In another permutation according to the present invention, a system is provided having a network connection device, a first network device, and a second network device. The first network device and the second network device may be coupled together in a network topology configured so that a single port on the network connection device supports network connectivity to both the first network device and second network device. The single port may provide power and data to an input port on the first network device. An output port on the first network device may provide power and data to the second network device. The network connection device may be a Power over Ethernet switch. The network connection device may be selected from one of the following: a hub, a switch, or a router. The network connection device may be a Power over Ethernet switch.

The power received from the single port may be at a level that conforms to IEEE 802.3af standard. The power transmitted by the first network device may be at a level that conforms to IEEE 802.3af standard. The first network device may be a network security device. The first network device may be a wireless intrusion detection sensor. The first network device may have a power passthru configuration wherein power received on a first port of the first network device is substantially the same as power transmitted on an output port of the first network device, without adding additional power from another source. A third network device may communicatively coupled to the second network device. The input port and output port may be configurable to support either IEEE 802.3af or Cisco pre-802.3af proprietary protocols.

In yet another embodiment according to the present invention, a system is provided having a network connection device, a network security device; and a network device providing a wireless access point. The network security device and the wireless access point may be coupled together in a network topology configured so that a single port on the network connection device supports network connectivity to both the network security device and the wireless access point. The network security device may have a power passthru configuration wherein power received on a first port of the security device is substantially the same as power transmitted on an output port of the security device, without adding additional power from another source.

The network connection device may be selected from one of the following: a hub, a switch, or a router. The network connection device may be a Power over Ethernet switch. The network security device may be both communicatively coupled to the same port on the network connection device. The network topology may include a network connection device communicatively coupled to the network security device which is communicatively coupled to the wireless access point. In one embodiment, a first port on the network security device may receive power and data from the single port on the network connection device. A second port on the network security device may transmit power and data to the wireless access point. In another embodiment, a first port on the network security device receives only data from the single port on the network connection device and a second port on the network security device transmits power and data to the wireless access point, wherein the power is transmitted by the network security device without receiving power from the network connection device. In yet another embodiment, a first port on the network security device receives only data from the single port on the network connection device; a second port on the network security device transmits only data to the wireless access point, wherein the network security device and the wireless access point each receive power from their own power source.

The network topology may comprise of the network connection device communicatively coupled to the wireless access point which is in turn communicatively coupled to the network security device. In another embodiment, a first port on the wireless access point receives power and data from the single port on the network connection device while a second port on the wireless access point transmits power and data to the network security device. In a still further embodiment, a first port on the wireless access point receives only data from the single port on the network connection device while a second port on the wireless access point transmits power and data to the network connection device, wherein the power is transmitted by the wireless access point without receiving power from the network connection device. In another embodiment, a first port on the wireless access point receives only data from the single port on the network connection device while a second port on the wireless access point transmits only data to the network security device, wherein the network security device and the wireless access point each receive power from their own power source. The network connection device may be a Power over Ethernet switch and provides power and data to both the network security device and the wireless access point. The power received from the single port may be at a level that conforms to IEEE 802.3af standard. The power transmitted by the network security device may be at a level that conforms to IEEE 802.3af standard. The network security device may be a wireless intrusion detection sensor. The network security device may have a power passthru configuration wherein power received on a first port of the security device is substantially the same as power transmitted on an output port of the security device, without adding additional power from another source.

In another embodiment according to the present invention, a device is provided having a controller with an input stage, a processing stage, and an output stage. The device may include a network interface comprising a first port for receiving data and power on a cable from a first network device. The interface may include a second port for transmitting data and power on a cable to a second network device. The controller may be configured to allow power to pass from the input stage through to the output stage which combines the power with the data and out a single port. In one embodiment, a network security device may be coupled to the controller.

In yet another embodiment according to the present invention, a device is provided that comprises of a wireless instruction detection sensor configured to both receive and inject power and powers itself off the received power. The power may be about 18 watts or less.

In another permutation according to the present invention, a device is provided that comprises of a low-power switch that operates on significantly less than 20 watts of power. The device includes a network interface having a first port that receives power and data from a first network device. The interface may include a second port that transmits power and data to a second network device. The interface may further include a third port that transmits power and data to a third network device. In one embodiment, the low-power switch and/or security device consumes less than about 4.5 watts, so that within an 18 W budget, there is plenty of headroom for the second device.

In a still further embodiment according to the present invention, a method is provided for installing an additional network device into an existing computer network. The method comprises disconnecting a first network device from a network connection device and communicatively coupling the additional network device between the network connection device and the first network device. The data from the network connection device flows through the additional network device to reach the first network device. The additional network device provides power and data to the first network device. The additional device may have input and output side adjustment of power protocol, allowing the device to be used IEEE 802.3af or Cisco pre-802.3af protocols. The additional device may have a power passthru configuration. The additional device may receive power and data from the network connection device, wherein the additional device also powers itself off received power. The additional device may inject power and data onto a cable coupled to the first network device. The additional device may be a wireless intrusion detection sensor. The additional device may be a wireless intrusion detection sensor and wherein the sensor can receive and pass data. The additional device may be a wireless intrusion detection sensor and wherein the sensor can receive and pass data, without receiving or passing power to the second first network device. The additional device may have an input and output side adjustment of power protocol. The additional device has input and output side adjustment of power protocol, allowing the device to be used IEEE 802.3af or Cisco pre-802.3af protocols.

In yet another embodiment of the present invention, a method is provided for installing a wireless network security device into an existing computer network. The method comprises disconnecting a first network device from a network connection device. The method also includes communicatively coupling the wireless network security device between the network connection device and the first network device, wherein data from the network connection device flows through the wireless network security device to reach the first network device. The wireless network security device provides power and data to the first network device. The method may also include sending power from the network connection device to the wireless network security device.

A further understanding of the nature and advantages of the invention will become apparent by reference to the remaining portions of the specification and drawings.

### BRIEF DESCRIPTION OF THE FIGURES

FIG. 1 shows a typical network configuration with a wireless access point.

FIG. 2 shows a typical network with a wireless access point and a wireless security device.

FIG. 3 shows one network topology according to the present invention.

FIG. 4 is a schematic showing a device according to the present invention.

FIG. 5 is a schematic showing a filtering feature according to the present invention.

FIG. 6 shows another network topology according to the present invention.

FIG. 7 is schematic of one embodiment of a device for use in the network topology of FIG. 6.

FIG. 8 shows yet another network topology according to the present invention.

FIG. 9 shows a still further embodiment of a network topology according to the present invention.

FIG. 10 shows another network topology according to the present invention.

FIG. 11 is schematic of one embodiment of a device for use in the network topology of FIG. 10.

FIG. 12 shows another network topology for use with a reliable restart feature according to the present invention.

FIG. 13 shows one embodiment of a reliable restart hardware for use with a device according to the present invention.

FIG. 14 shows a chart describing reliable restart hardware logic.

FIGS. 15 and 16 show cables according to the present invention with a Y-adapter.

FIGS. 17A and 17B show an embodiment of the present invention using a low-power switch.

FIG. 18 shows one embodiment of a device for use in the network topology of FIG. 17A.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “cable” may include multiple cables, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for using a wireless connection, this means that the wireless feature may or may not be present, and, thus, the description includes structures wherein a device possesses the wireless feature and structures wherein the wireless feature is not present.

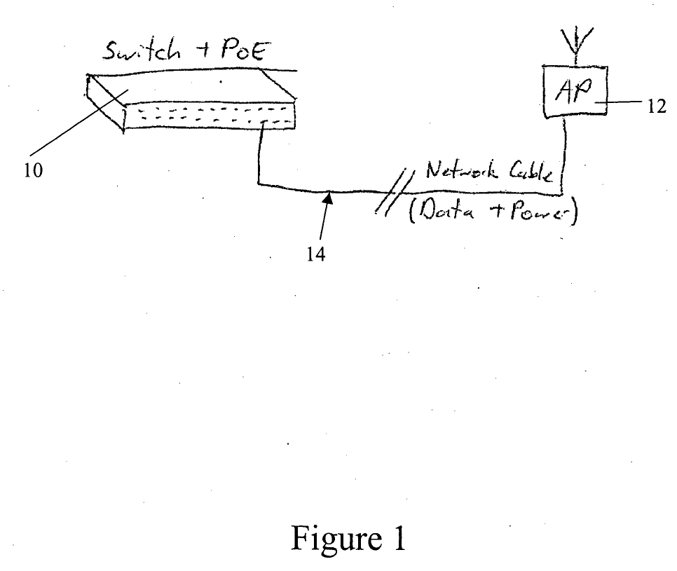

Referring now to FIG. 1, a network suitable for expansion using the present invention will be described in further detail. In the present embodiment, the network connection device 10 supporting the access point 12 may be a Power over Ethernet (POE) switch. This POE switch 10 is a specialized switch that can provide both power and data over the same cable. In this embodiment, the access point 12 will receive power from the switch 10 over the internet cable 14.

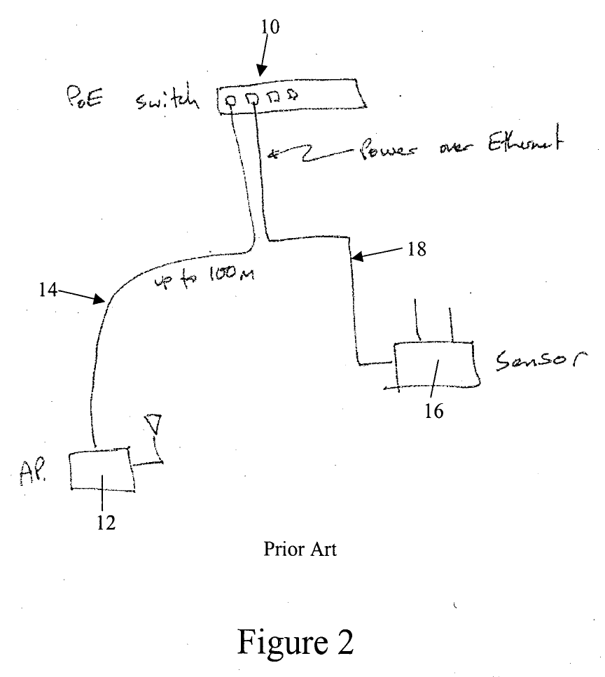

Referring now to FIG. 2, to deploy an additional security device 16 into the network of FIG. 1, the security device 16 may be positioned in the area to be covered, typically near the wireless access points 12 since the security devices 16 have a limited RF radio range. As previously described, the cost of laying the cable 18 to support the security device may cost as much or more than the security device itself. In addition to the cost of cabling, the cost of having a spare port on the network connection device 10 to support the security device 16 is another concern if the network does not have the excess capacity to handle the security device or sensor. As seen in FIG. 2, a traditional deployment uses two ports on the network connection device 10, one for the access point 12 and one for the network security device 16.

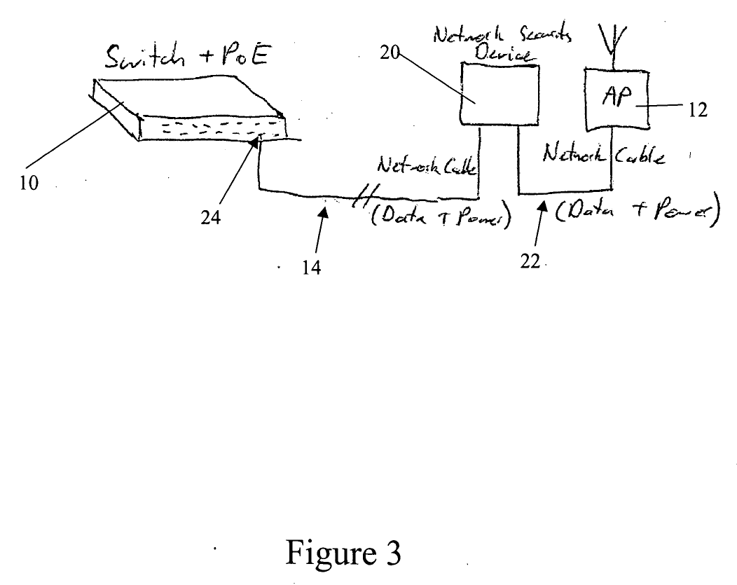

Referring now to FIG. 3, a network using one embodiment of the present invention for network expansion will now be described. The present invention allows for network expansion without substantial cost related to lay long runs of cable or using additional ports on the network connection device 10. In the embodiment shown in FIG. 3, the network security device 20 according to the present invention will enable Power over Ethernet passthru. By way of example and not limitation, the cable 14 originally from the switch 10 to the access point 12 is unplugged from the access point 12. Instead, the cable 14 is now coupled to the security device 20. Then another cable 22 is used to couple the security device 20 to the access point 12. In this network topology, both the security device 20 and the access point 12 are in communication with the POE switch 10 while utilizing only a single port 24 on the POE switch. The cost of running a cable 22 between the security device 20 and the access point 12 is relatively minor compared to running entirely new cable from the switch 10 since the security device 20 is typically located near the access point 12.

The passthru of data and power from the switch 10 to the security device 20 and then to the access point 12 enables the present invention to couple both devices via a single port 24 on the switch 10. The passthru of data and power allows the security device 20 to be placed into the existing network without using additional ports or requiring costly cable pulls from the switch 10 to the security device 20. The present invention uses a network security device 20 that can receive power in and also put power out. The present embodiment takes power into the device on a data line and puts power out on a data line. Most devices only receive power from the Wire. A device having a power receive port and a power inject port is desirable to facilitate insertion of the device into an existing network.

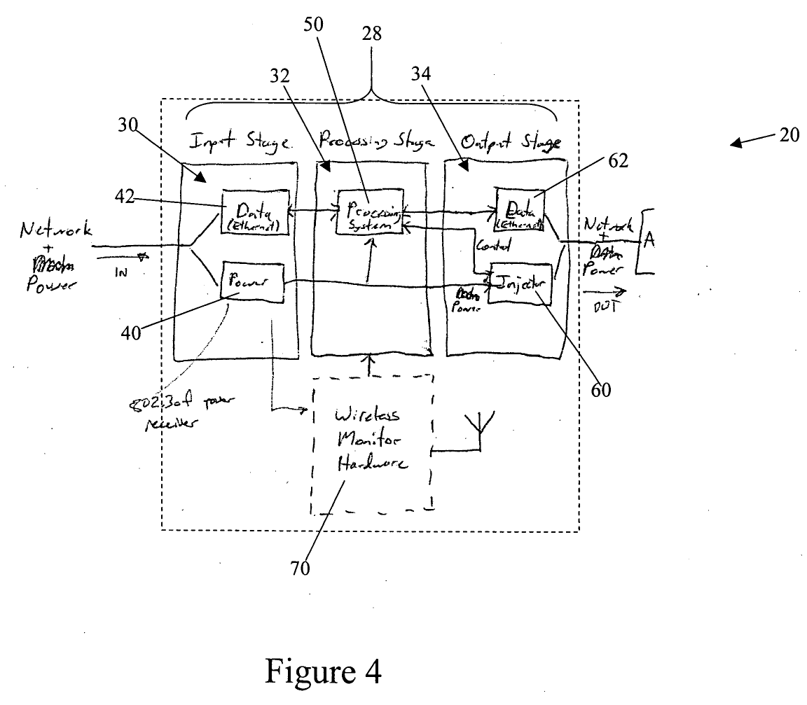

Referring now to FIG. 4, one embodiment of a network security device 20 according to the present invention will be described in further detail. The network security device 20 may comprise of controller or circuit 28 with an input stage 30, a processing stage 32, and an output stage 34.

In one embodiment, the input stage 30 may be configured as follows. The input stage 30 may comprise of a PoE end-point circuit 40 such that the network monitoring device can be powered, and a Ethernet data end-point circuit 42 such that the network monitoring device can communicate over Ethernet. The input stage 30 may be used to separate data from power being received from the PoE switch. The Ethernet end-point includes support for one or more standards, including but not limited to 100baseTX, 10baseT, etc.

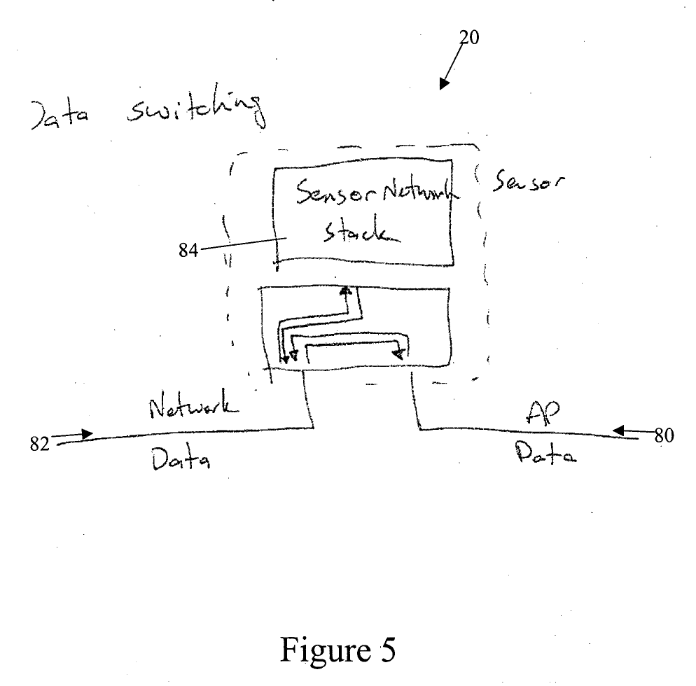

Referring still to FIG. 4, the processing stage 32 may optionally be configured as follows. The processing stage 32 may have a processor or processing system 50. In one implementation, all packets are bridged between the AP 12 and the network such that the operation of the AP 12 is unaffected. This traffic can be monitored or passed silently by the network security device 20. Packets may be filtered such that the network monitoring device is only network accessible from the network side and is inaccessible from the AP side (see FIG. 5). In one implementation the network security device 20 is monitoring wireless network traffic instead of or in addition to monitoring Ethernet communication. The 802.3af specification, for example, sets forth that power should only be injected if there is a device capable of receiving power plugged in. In addition, the power injection will stop if the powered device malfunctions or is unplugged. Optionally, an additional function of the processing stage is to monitor this and instruct the injector when to injector power and when not to. In one implementation, this function is done in the same CPU or processor 50 that also performs any network bridging functions and/or wireless security device functions.

Referring to FIG. 4, the output stage 34 may be configured as follows. The output stage 34 may comprise of a PoE injector circuit 60 such that the network monitoring device can power the AP, and a Ethernet data end-point 62 such that the network monitoring device can communicate to the AP over Ethernet.

One aspect of the implementation involves a hardware implementation that supports one or more power specifications. Optionally, the PoE end-point includes support for one or more standards/conventions, including IEEE 802.3af PoE, Cisco single port injectors, Cisco pre-802.3af PoE switches, etc. . . . In one embodiment, it may be support for the 802.3af standard. In another embodiment, the device supports a legacy Cisco power specification. The device may detect which power specification is used in the system and automatically configure the device for the power specification in use. This may be used on both the receive side and the output side, allowing the device to be used with an input that meets the 802.3af specification or meets some other specification such Cisco legacy specification. There is logic in the system that adjusts the specification on the input side and the output side independently. This logic may reside in processor 50 or may be with the power circuits in the input or output stages.

In embodiments supporting both IEEE 802.3af devices and Cisco pre-802.3af, the device having such a feature may involve two aspects—power protocol detection and power supply. Detection of the power protocol may involve the following. The IEEE 802.3af standard sets forth that the low-voltage resistance be within a given range and that the low-voltage capacitance be less than a given value. Cisco devices can be detected by their resistance/capacitance signature with appropriate hardware that has sufficient dynamic range to measure the resistance and capacitance ranges of both IEEE 802.3af compliant devices and Cisco pre-802.3af devices. The logic for detecting the power protocol may be found in the processor 50, the injector 60, and or some portion of the output stage circuit 34. Logic for such detection may also be found in the input stage circuit 30. In the present implementation, the logic for making the determination is in the processor 50.

Supplying power in the correct protocol may involve the following. Cisco pre-802.3af devices require power on the unused pairs in the reverse polarity to that specified by the 802.3af standard. This can be addressed in a number of ways including, providing power in the reverse polarity on the unused pairs for both types of devices relying on the 802.3af requirement that 802.3af devices accept power in either polarity, providing power on the unused pairs in dynamically chosen polarity to match the device based on the detection signature, or providing power for 802.3af devices on the data pairs and providing power for Cisco pre-802.3af devices on the unused pairs based on the detection signature.

Additionally, the PoE detection feature and monitoring state-machine may be implemented in whole or in part in the main packet processor 50. In one implementation the main packet processor is responsible for the PoE state-machine that goes through the different stages required to detect a PoE capable device, evaluate the device signature, enable power, to monitor the power consumption, and to detect when the device is no longer present. Furthermore, the analogue to digital detection and digital to analogue control may be implemented directly in the main packet processor by using built-in analogue support or by using resistor-capacitor timed digital sampling techniques.

Referring still to FIG. 4, the wireless security monitor or hardware 70 is the network security portion of the device. The network security function in the device may be a wireless intrusion detection sensor, or optionally could be any other computing or monitoring function that could be achieved within a reasonable power budget. At a general level, in one embodiment, the device 20 performs some other function besides providing network connectivity and is not simply an Ethernet switch. Thus in other embodiments, the hardware 70 may also be designed to provide some other functionality besides network security. In essence, this device can thus pass power through and perform an additional function. Although not limited to the following, some examples might include: a wireless access point, a door lock, a thermostat, an HVAC controller, a burglar alarm sensor, a security camera, or a firewall.

Referring now to FIG. 5, in yet another aspect of the present invention, the processing stage 32 may optionally be implemented with filtering that allows data to flow in only certain directions. This data switching limits access for those connections coming from the access points. As seen in FIG. 5, packets 80 from the access point 12 pass straight through the network security device 20. Data can go from the access point 12 to the network. Data 82 can go from the network to the access point 12. The data can go from the network to the sensor stack 84. Data can go from the sensor stack 84 to the network. Data cannot go from the sensor stack 84 to the access point 12 or vice versa. This provides a level of security for the network security device 20. This means that an intruder cannot access the network security device directly. This is desirable since network security devices are deployed near the edges of the network and the connected device, like a wireless access point, may be vulnerable to breach from unauthorized people.

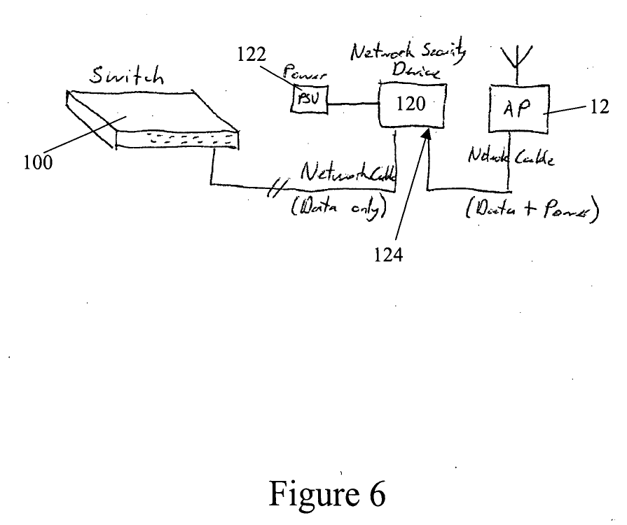

Referring now to FIG. 6, another permutation of the present invention will now be described. FIG. 6 shows another network topology according to the present invention. In this embodiment, the network connection device 100 is a normal switch and not a POE switch or network connection device. As seen, the network security device 120 only receives data from the switch 100 and no power. Power is provided locally to the network security device 120 by a power source 122. The network security device 120 may then inject power along with data from a second port 124 on a cable or other connection to the access point 12. Such a network configuration may be useful in legacy configurations where the access point 12 is already installed and there may be only one power outlet. Power is unplugged from the access point 12 and plugged into the network security device. This allows both devices to be powered. The outlet or other power source 122 powers the security device 120 which then powers the access point. In either of the network topologies shown in FIGS. 3 or 6, upstream from the network device 20 may vary, depending on where power is being provided. Downstream from the device 20 is substantially the same for both embodiments, where the data and power are injected onto the line for the access point 12.

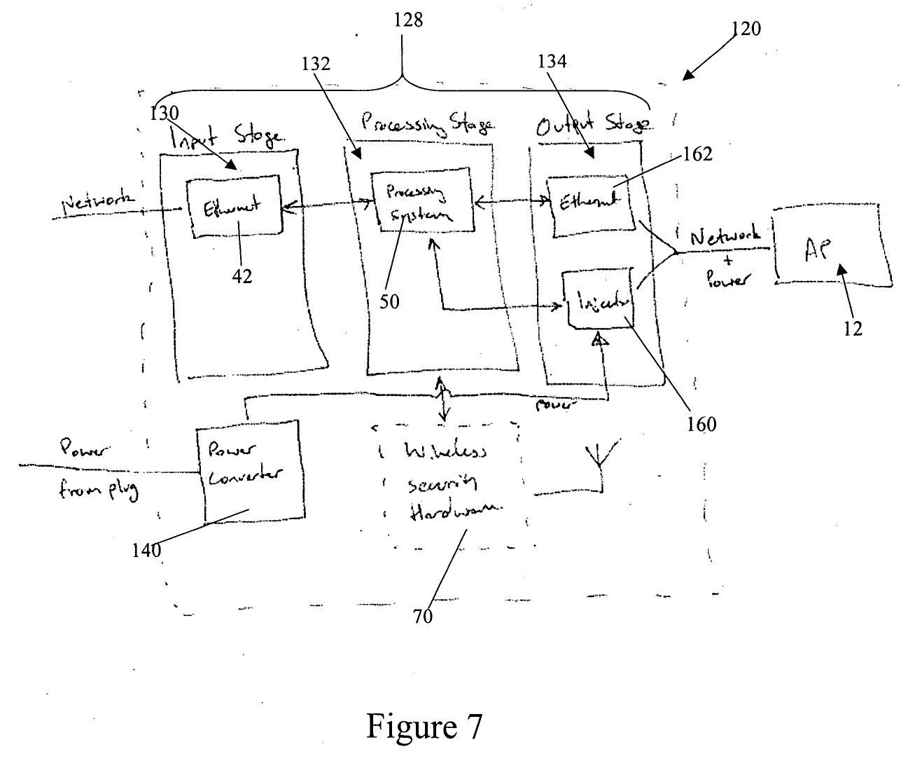

FIG. 7 shows one embodiment of a network security device 120 for use in a network topology as described in FIG. 6. As seen in FIG. 7, the network security device 120 may comprise of a controller or circuit 128 with an input stage 130, a processing stage 132, and an output stage 134. The wireless security hardware 170 communicates with the processing stage 132 to address any network security issues, similar to that of the device in FIG. 4.

In the present embodiment, the input stage 130 may include an Ethernet data end-point circuit 42 such that the network monitoring device can communicate over Ethernet. The Ethernet end-point includes support for one or more standards, including but not limited to 100baseTX, 10baseT, etc. It should be understood that other circuits supporting other data protocols may also be used. Since there is no power being received on the data line, the input stage 130 does not include a circuit 40 for separating power from the data. Instead, as seen in FIG. 7, power is provided from a separate source to a power converter 140. From the power converter 140, power is used to power the device 120. Power is also supplied to the injector 160 in the output stage 134 to inject power and data to a network device downstream from device 120.

In the present embodiment of device 120, the processing stage 132 may have a processing system 50. In one implementation, all packets are bridged between the AP 12 and the network such that the operation of the AP 12 is unaffected. This traffic can be monitored or passed silently by the network security device 120. Packets may be filtered such that the network monitoring device is only network accessible from the network side and is inaccessible from the AP side (see FIG. 5). The processing system 150 may be substantially similar to the processor described in FIG. 4.

In the present embodiment, the output stage 134 may comprise of a PoE injector circuit 160 such that the network monitoring device can power the AP 12, and a Ethernet data end-point 162 such that the network monitoring device can communicate to the AP over Ethernet. It should be understood that the injector circuit 160 may support other protocols such as but not limited to Cisco pre-802.3af protocol. Similar to the circuit in FIG. 4, the device 120 may detect the power protocol used in the downstream device, and the circuit 160 may then be configured to support the appropriate power protocol.

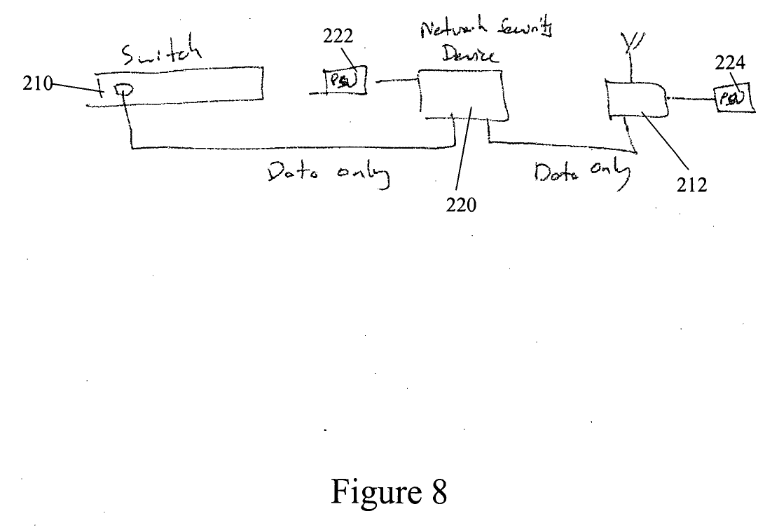

Referring now to FIG. 8, yet another permutation of the present invention will now be described. FIG. 8 shows an embodiment where the access point 212 does not support POE and the device 220 only receives data. Data is passed from the wireless intrusion network device 220 to the access point 212 and vice versa. In this embodiment, access point 212 and network security device 220 both have their own power sources 222 and 224.

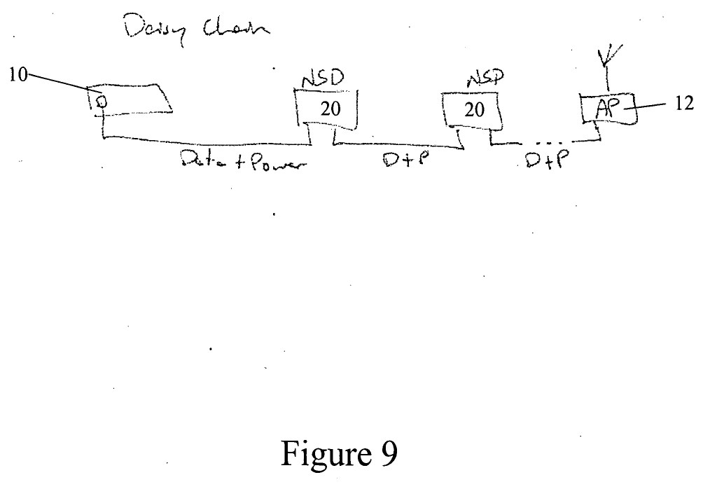

Referring now to FIG. 9, yet another permutation of the present invention involves the daisy-chaining of a plurality of devices 20 together in the chain with the access point 12. In some embodiments, the access point 12 is downstream of one or more network security devices 20 and/or access points. The data and power are passed through the cable to the devices.

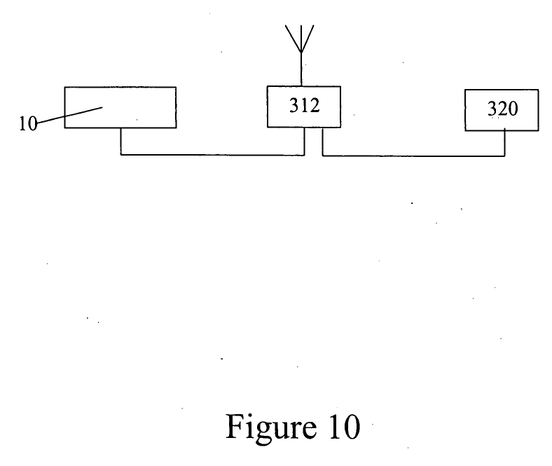

Referring now to FIG. 10, yet another permutation of the present invention will now be described. In another aspect of the present invention, the access point 312 is upstream of the network security device 320 and passes power to the security device. This involves a customized access point 312 with the ability to receive power and to inject power to a line coupling to a device downstream.

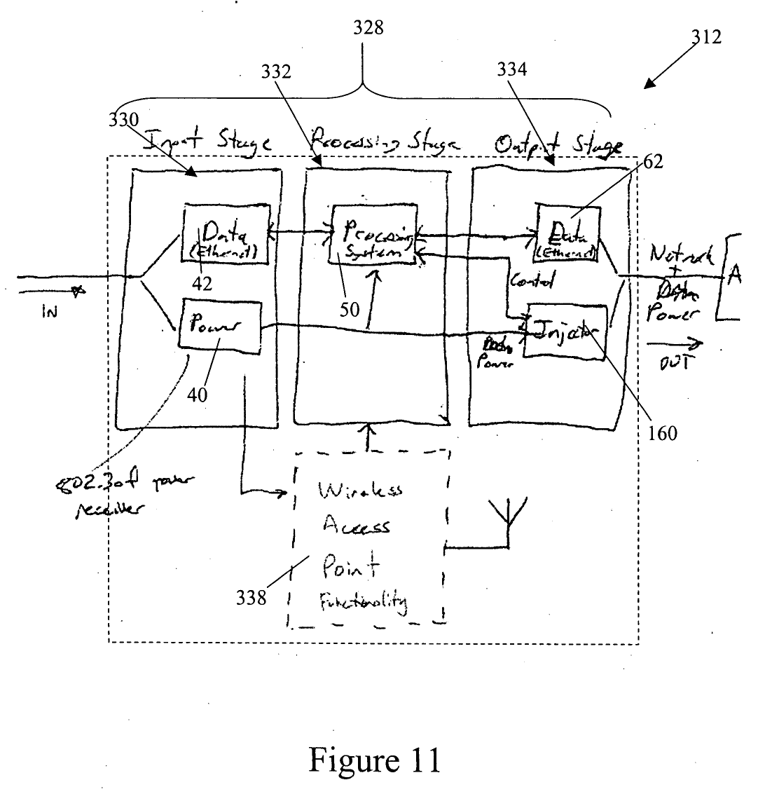

FIG. 11 shows one embodiment of a customized access point 312 for use with the present invention. The device 312 is similar to the device 20 of FIG. 4, except that the network security functionality is replaced by hardware 338 providing a wireless access point functionality. The hardware 338 is in communication with the processing stage 332 to provide wireless access point functionality and to connect the hardware 338 to the rest of the network.

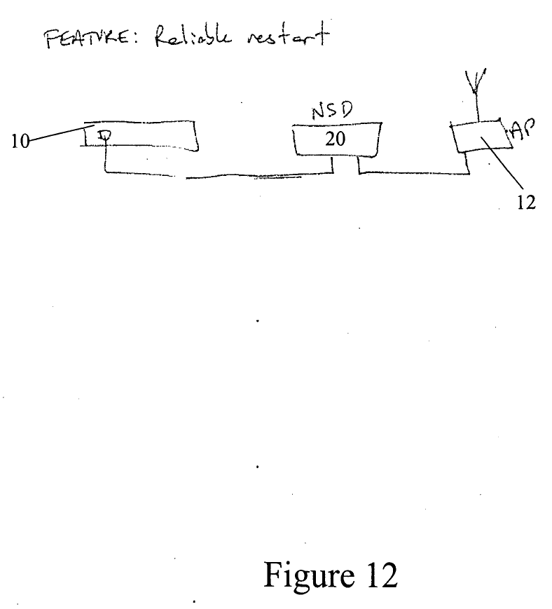

Referring now to FIG. 12, yet another aspect of the present invention will now be described. Optionally, a reliable restart feature may be included with embodiments of the present invention. Since the access point 12 is receiving its power from the network security device 20, the power passing through the network security device 20 is under the control of the CPU or processor 50 in the network security device. If the CPU 50 stops for any reason such as a reboot or other power disruption, power to the access point will be interrupted. Periodically, the network security device 20 may be rebooted to make configuration changes or the like and disruption to the downstream access point may occur. The present invention has a hardware design configured to allow a network security device reboot without power disruption to devices downstream from the network security device. This is achieved with hardware that can detect if the processor is actively controlling the power state for the downstream device. If the processor is actively controlling the power state then the downstream device will be ON or OFF as controlled by the processor. If the hardware detects that the processor is no longer actively controlling the power state then the hardware will maintain the existing ON/OFF state with a timeout long enough for the processor to reboot and reassert control.

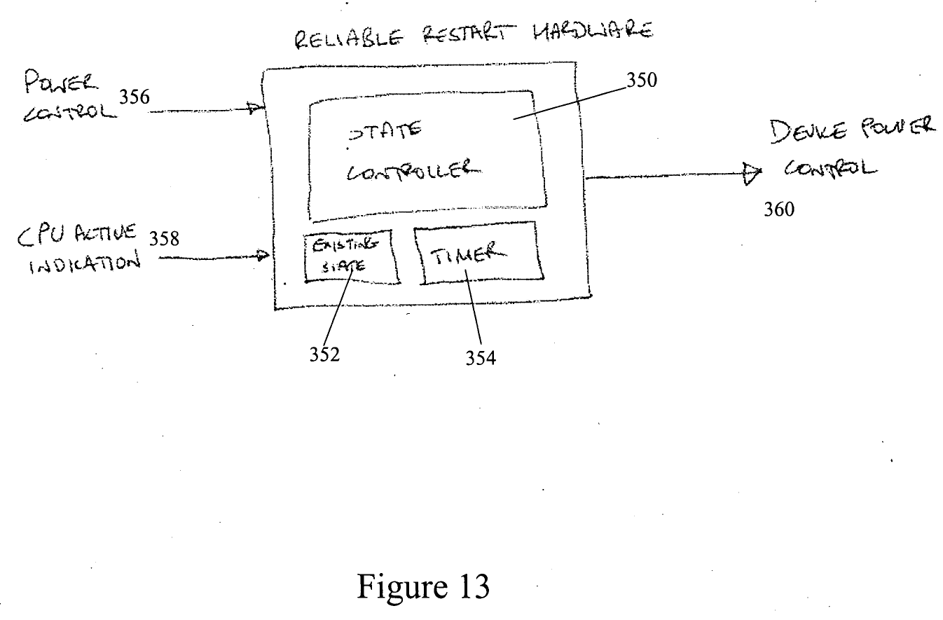

FIG. 13 shows one embodiment of the reliable restart hardware. The state controller 350 uses two inputs as well as knowledge of the existing state 352 and a timer 354 to determine whether the device power control output should be on or off. The two inputs may be power control input 356 and CPU active indication input 358. When the device power control output 360 is ON, the device connected to the power output 360 of the network security device will be powered on. The power control input 356 is provided directly from the processor 50.

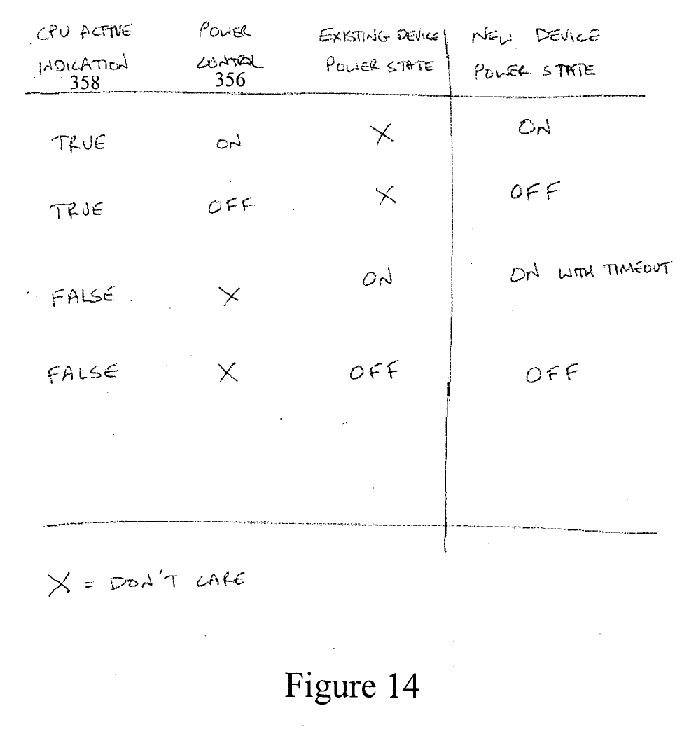

FIG. 14 shows the state table for the state controller 350 in FIG. 13. The inputs marked with an X are “don't care” inputs which have no effect on the output. When the new device power state is “on with timeout” the device power control signal will be on, but after a short time (typically 3 seconds) it is turned off. The logic set forth in FIG. 14 may be implemented using a controller 350 or incorporated into a processor 50 described in the various devices.

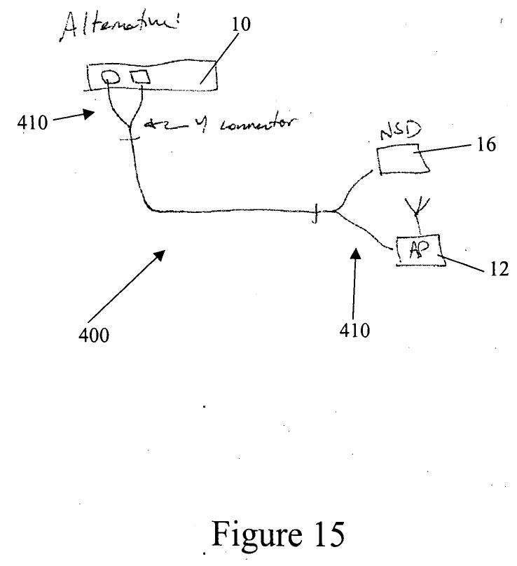

Referring now to FIG. 15, another aspect of the present invention will now be described. A specialized cable 400 with a Y-connector used to couple a network security device and access point to a switch. This is a nonstandard cable. In some embodiments, they can optionally use an Y-adapter 410 coupled to the normal cable. The device uses two switch ports on switch 10 to support the devices. Normal Ethernet cables contain 8 wires arranged as four pairs of two wires each. A typical end-span PoE injector will only use two of the four pairs. By carefully wiring a Y connector two Ethernet and power streams can share the same Ethernet cable. At the end of the cable a Y splitter is used to separate the wires again.

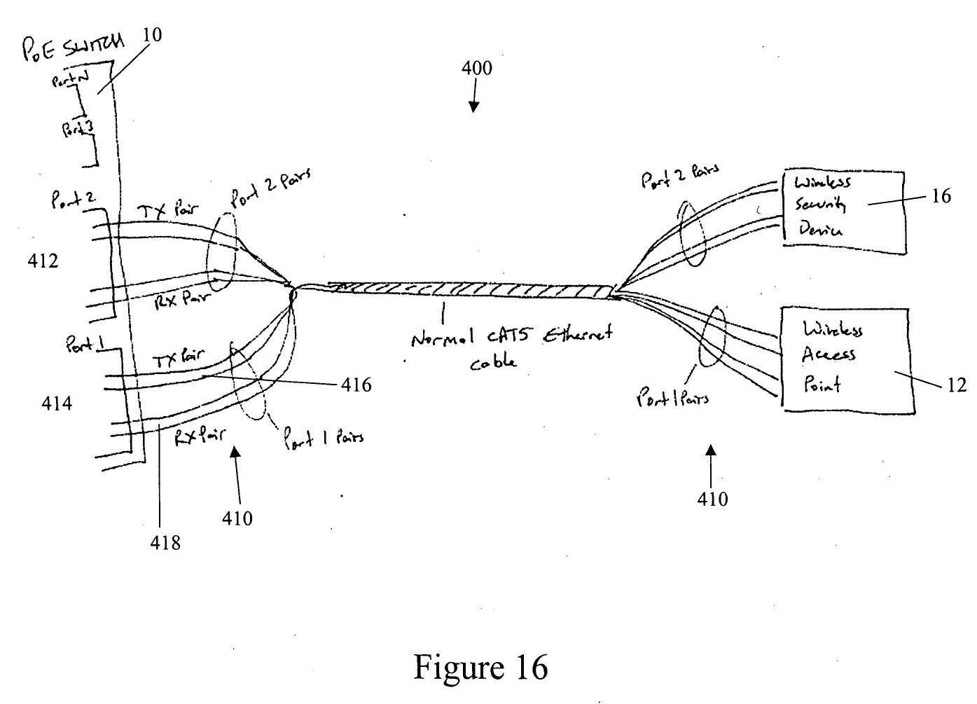

FIG. 16 more clearly shows one embodiment of a Y-cable for use in a topology as described in FIG. 15. The cable 400 may use a normal CAT5 ethernet cable for a portion of the cable. The cable 400 may fitted with Y-adapters 410. In one embodiment, the Y-adapter 410 may be used to coupled two ports 412 and 414 to the same cable 400. Each “leg” of the Y-adapter may include a transmit (Tx) wire pair 416 and a receive (Rx) wire pair 418. Although using two ports on the network connection device 10, this cable 400 allows the single original cable to support more than one downstream device. This reduces the significant cost of having to lay a new cable, though it uses a second port on the network connection device 10.

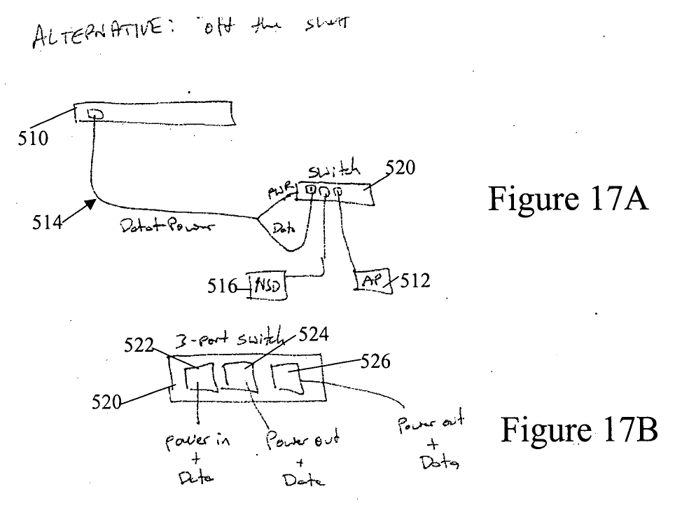

Referring now to FIGS. 17A and 17B, yet another aspect of the present invention will now be described. Referring now to FIG. 12a, this network topology preferably uses a network connection device 510 providing more than 18 watts of power on cable 514. This provides sufficient power budget so that two devices such as but not limited to the access point 512 and network security device 516 can be powered off the power sent to a three-port switch 520. The network connection device 510 is preferably capable of providing enough power for all devices that are cascaded downstream from the device 510. By way of nonlimiting example, a typical AP will use in the order of about 6 watts so the 18 watt number is a good example. However as another example, three cascaded 1 watt devices would only require a switch capable of supplying 3 watts. Preferably, a plurality of devices can be coupled so long as the network connection device 510 is capable of providing enough power for all of the devices that are cascaded downstream.

Referring now to FIG. 17B, this shows one embodiment of a low power switch 520. The device allows for two separate boxes or housings, one with the security feature and the other with a low powered switch. The present invention provides a three port switch where one port 522 is power in with data, a second port 524 is power out with data, and a third port 526 is power out plus data. By using a switch 520 according to the present invention, off the shelf devices may be used in this network topology.

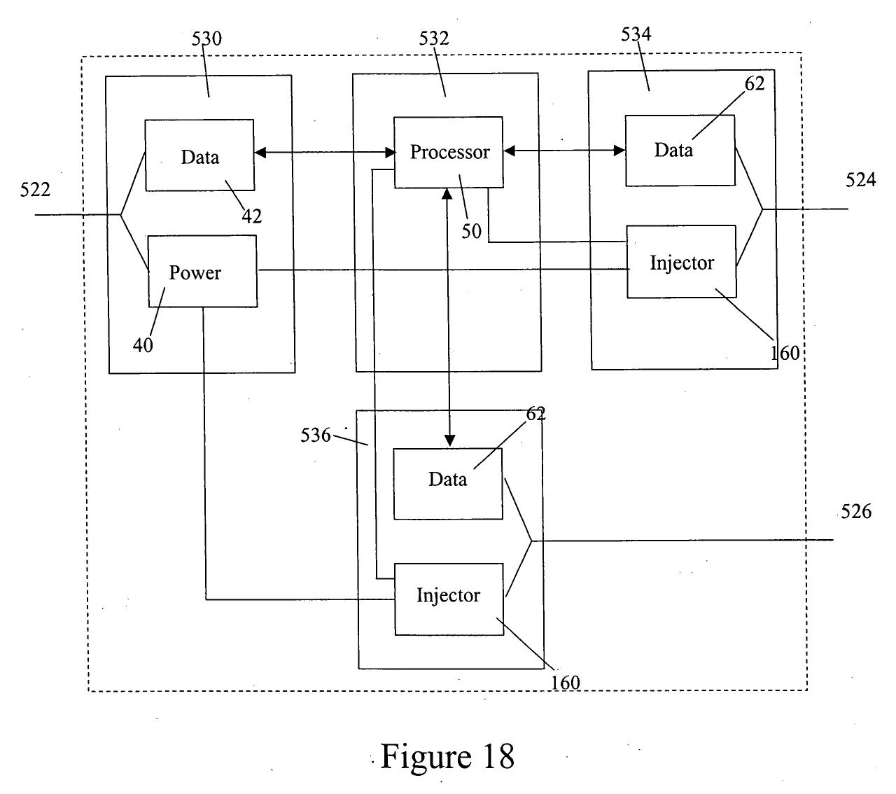

Referring to FIG. 18, one embodiment of a network connection device 520 according to the present invention for use in a topology shown in FIG. 17 will now be described. The network connection device 520 includes one input stage 530, a processor stage 532, a first output stage 534, and a second output stage 536. Each output stage 532 and 534 provides power and data to ports 524 and 526, respectively. This provides power and data connectivity to those devices coupled to ports 524 and 526. Similar to the other embodiments, the appropriate power protocol may be selectively configured to match the power protocol used by the downstream device. By way of nonlimiting example, the processor 50 or the output stages 534/536 may contain the logic to determine what power protocol to use. The ports 524 and 526 may simultaneously use the same or different power protocols. It should be understood that the network connection device 520 may be designed to have more than two ports 524 and 526.

Other embodiments may incorporate three, four, five, six, or more ports to power more downstream devices. Some embodiments may cascade two or more network connection devices together to provide more power/data ports.

Optionally, the network monitoring or security device may include remote access features. The device may control power and network connection to the PoE device that it is inline with. This may allow for remotely monitoring the power consumption of device, the network utilization of the device, rate throttling of network traffic to/from the device, firewall or packet filtering of network traffic to/from the device, ability to remotely power down or reboot the device, etc.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, the function performed by the wireless security device may be any function suitable for a networked device, not necessarily related to security. It does not matter whether the devices are using 10 Mbps, 100 Mbps or any other data rate Ethernet. The network bridging functionality between the two ports may be implemented in the main processing unit, or in a dedicated processing unit, e.g. a switch chipset. For any of the above embodiments, it should be understood that the present invention is also applicable to new network installation. The present invention may halve the number of wire pulls used in new network installations. By way of nonlimiting example for any of the above embodiments, the network connection device may be a hub, a switch, or a router. It may be a wired or wireless device. For any of the above embodiments, the various stages (input, output, processor, etc. . . . ) may be part of the same circuit or may be separate circuits. It should be understood that the present invention may optionally support a third, fourth, or other power specifications besides IEEE 802.3af or Cisco proprietary power specifications.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Expected variations or differences in the results are contemplated in accordance with the objects and practices of the present invention. It is intended, therefore, that the invention be defined by the scope of the claims which follow and that such claims be interpreted as broadly as is reasonable.

1. An apparatus for use in a network to facilitate network expansion, the apparatus comprising:
a processor; and
a network interface comprising:
a first port for receiving both power and data transmitted from a first network device;
a second port for transmitting both power and data to a second network device;
wherein the network interface communicatively couples the processor to the network and the network interface is configured so that data received on the first port can be transmitted out the second port to an appropriate destination.

2. The apparatus of claim 1 wherein a processor is configured to route data from the first port or the second port to the appropriate destination.

3. The apparatus of claim 1 wherein data received on the second port can be transmitted out the first port.

4. The apparatus of claim 1 further comprising a first circuit defining an input stage between the first port and the processor, wherein the input stage is configured to separate data from the power being received at the first port.

5. The apparatus of claim 1 further comprising a second circuit defining an output stage between the second port and the processor, wherein the output stage is configured to combine data with the power to be transmitted out the second port.

6. The apparatus of claim 1 wherein the apparatus operates on a portion of the power received via the first port.

7. The apparatus of claim 1 further comprising:
a network intrusion detection sensor that operates on a portion of the power received from the first port.

8. The apparatus of claim 1 further comprising:
a wireless network intrusion detection sensor that operates on a portion of the power received from the first port.

9. The apparatus of claim 1 further comprising:
a network intrusion detection sensor that is communicatively coupled to first circuit to receiving power from the first port.

10. The apparatus of claim 1 further comprising:
a wireless network intrusion detection sensor that is communicatively coupled to first circuit to receiving power from the first port.

11. The apparatus of claim 1 wherein the first network device is a Power over Ethernet switch.

12. The apparatus of claim 1 wherein the first network device is a device providing a wireless access point.

13. The apparatus of claim 1 wherein the power received by the first port is at a level that conforms to IEEE 802.3af standard.

14. The apparatus of claim 1 wherein the power transmitted by the second port is at a level that conforms to IEEE 802.3af standard.

15. The apparatus of claim 1 wherein the power transmitted by the second port is about 18 watts or less.

16. The apparatus of claim 1 wherein:
the apparatus has a power passthru configuration wherein power received on the first port is substantially the same as the power transmitted on the output port, without adding additional power.

17. The apparatus of claim 1 wherein the processor includes a sensor network stack, wherein the processor is configured so that data coming upstream from a downstream network device cannot directly access the sensor network stack in the processor.

18. The apparatus of claim 1 wherein the network interface further comprises:
a third port for transmitting power and data to a third network device.

19. The apparatus of claim 1 wherein the processor has a configuration sufficient to allow a software reboot of the device without interruption of power flowing through the apparatus to the second network device.

20. The apparatus of claim 2 wherein input stage has logic configured to determine which power protocol is being used with the power being received.

21. The apparatus of claim 3 wherein output stage has logic configured to determine which power protocol is to be used with the second network device.

22. The apparatus of claim 2 wherein input stage can be used with network devices using either IEEE 802.3af or Cisco pre-802.3af proprietary protocols.

23. The apparatus of claim 1 further comprising a device providing a function unrelated to routing of data.

24. A system comprising:
a network connection device;
a first network device; and
a second network device;
wherein the first network device and the second network device are coupled together in a network topology configured so that a single port on the network connection device supports network connectivity to both the first network device and second network device;
wherein the single port provides power and data to an input port on the first network device;
wherein an output port on the first network device provides power and data to the second network device.

25. The system of claim 24 wherein the network connection device is selected from one of the following: a hub, a switch, or a router.

26. The system of claim 24 wherein the network connection device is a Power over Ethernet switch.

27. The system of claim 24 wherein the power received from the single port is at a level that conforms to IEEE 802.3af standard.

28. The system of claim 24 wherein the power transmitted by the first network device is at a level that conforms to IEEE 802.3af standard.

29. The system of claim 24 wherein the first network device is a network security device.

30. The system of claim 24 wherein the first network device is a wireless intrusion detection sensor.

31. The system of claim 24 wherein:
the first network device has a power passthru configuration wherein power received on a first port of the first network device is substantially the same as power transmitted on an output port of the first network device, without adding additional power from another source.

32. The system of claim 24 further comprising a third network device communicatively coupled to the second network device.

33. The apparatus of claim 24 wherein the input port and output port are configurable to support either IEEE 802.3af or Cisco pre-802.3af proprietary protocols.

34. A method for installing an additional network device into an existing computer network, the method comprising:
disconnecting a first network device from a network connection device; and
communicatively coupling the additional network device between the network connection device and the first network device, wherein data from the network connection device flows through the additional network device to reach the first network device;
wherein the additional network device provides power and data to the first network device.

35. The method of claim 34 wherein the additional device has a power passthru configuration.

36. The method of claim 34 wherein:
the additional device receives power and data from the network connection device, wherein the additional device also powers itself off received power;
the additional device injects power and data onto a cable coupled to the first network device.

37. The method of claim 34 wherein the additional device is a wireless intrusion detection sensor.

38. The method of claim 34 wherein the additional device is a wireless intrusion detection sensor and wherein the sensor can receive and pass data.

39. The method of claim 34 wherein the additional device is a wireless intrusion detection sensor and wherein the sensor can receive and pass data, without receiving or passing power to the second first network device.

40. The method of claim 34 wherein the additional device has input and output side adjustment of power protocol.

41. The method of claim 34 wherein the additional device has input and output side adjustment of power protocol, allowing the device to be used IEEE 802.3af or Cisco pre-802.3af protocols.
